(19) United States
(12) Patent Application Publication
(10) Pub. No.: US 2018/0183533 A1
(43) Pub. Date: Jun. 28, 2018

(54) TERMINAL APPARATUS, INFORMATION PROVIDING SYSTEM, TERMINAL APPARATUS PROCESSING METHOD, AND PROGRAM

(71) Applicant: NEC CORPORATION, Tokyo (JP)

(72) Inventor: Mitsunori MORISAKI, Tokyo (JP)

(21) Appl. No.: 15/822,835

(22) Filed: Nov. 27, 2017

(30) Foreign Application Priority Data
Dec. 28, 2016 (JP) 2016-254859

(51) Int. Cl. H04H 20/31; G06F 17/30; G10H 1/00

(52) U.S. Cl. CPC H04H 20/31; G06F 17/30749; G10H 2240/041; G10H 2240/091; G06F 17/30026; G10H 1/0008

(57) ABSTRACT

Provided is a terminal apparatus including a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and an information extraction unit configured to retain multiple spreading codes and extract the information from the target data using a spreading code selected by a user.

This application is based on Japanese patent application No. 2016-254859 filed Dec. 28, 2016, the content of which is incorporated hereinto by reference.

### BACKGROUND

### Technical Field

The invention relates to a terminal apparatus, an information providing system, a terminal apparatus processing method, and a program.

### Related Art

Japanese Patent Application Publication No. 2011-215189 discloses a unit configured to superimpose content-specifying information on an audio for transmission and reception. As the superimposing technique, a method for multiplying the content-specifying information by a spreading code and then superimposing the result on audio data is disclosed. Further, as a method of transmission and reception of information between apparatuses, a technique is disclosed in which one apparatus reproduces audio data superimposed with information and the other apparatus collects audios using a microphone.

### SUMMARY

Various advantageous effects are obtained from superimposing a variety of information on a variety of audios for transmission and reception. For example, by superimposing a variety of information on audios output from a television or a radio, it is possible to increase the number of ways of enjoying broadcasting. Further, by superimposing a variety of information on audios output from a telephone, it is possible to enhance convenience of the telephone.

However, in a case where the number of kinds of audios superimposed with information increases and are abundant in the vicinity, there may be a situation in which information cannot be properly extracted from audio data. For example, a variety of audios output from a television, a radio, a telephone, or the like may be collected at the same timing. That is, audio data in a state where the audios are superimposed may be acquired on a receiver side through a microphone, or the like. In a case where information which is encoded using the same spreading code is superimposed on a variety of audios output from a television, a radio, a telephone, or the like, if superimposed information is extracted by decoding using the spreading code, audio data including information superimposed on each of audios of a television, a radio, or a telephone would be extracted in an overlapped manner. That is, information cannot be properly extracted.

An object of the invention is to provide a new technique relating to a method for superimposing information on an audio for transmission and reception.

In one exemplary embodiment, there is provided a terminal apparatus including:

a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and

an information extraction unit configured to retain a plurality of spreading codes and extract the information from the target data using a spreading code selected by a user.

In another exemplary embodiment, there is provided an information providing system including: the above-mentioned terminal apparatus; a generation apparatus that transmits superimposed data obtained by superimposing spread encoded information on non-spread encoded audio data; and an audio output apparatus that outputs an audio on the basis of the superimposed data.

In still another exemplary embodiment, there is provided an information providing system including: a terminal apparatus; and an apparatus that superimposes spread encoded information on non-spread encoded audio data and outputs an audio on the basis of the superimposed data.

In still another exemplary embodiment, there is provided a terminal apparatus processing method causing a computer to execute:

acquiring target data which is: superimposed data, obtained by superimposing spread encoded data on non-spread encoded audio data, the spread encoded data obtained by encoding information using a spreading code; or data obtained by converting sound reproduced on the basis of the superimposed data into an electrical signal; and

retaining a plurality of spread codes and extracting the information from the target data using a spread code selected by a user.

In still another exemplary embodiment, there is provided a program that causes a computer to function as:

a target data acquisition unit configured to acquire target data which is: superimposed data obtained by superimposing spread encoded data on non-spread encoded audio data; or data obtained by converting sound reproduced on the basis of the superimposed data into an electrical signal; and

an information extraction unit configured to retain a plurality of spreading codes and extract the information from the target data using a spreading code selected by a user.

According to the present invention, a new technique relating to a method for superimposing information on an audio for transmission and reception is achieved.

### BRIEF DESCRIPTION OF THE DRAWINGS

The above and other objects, advantages and features of the present invention will be more apparent from the following description of certain preferred exemplary embodiments taken in conjunction with the accompanying drawings.

FIG. 1 is an example of a functional block diagram of an information providing system according to an exemplary embodiment.

FIG. 2 is a conceptual diagram showing an example of a hardware configuration of an apparatus according to the exemplary embodiment.

FIG. 3 is an example of a functional block diagram of a generation apparatus according to the exemplary embodiment.

FIG. 4 is an example of a functional block diagram of a terminal apparatus according to the exemplary embodiment.

FIG. 5 is a schematic diagram showing an example of information processed by the terminal apparatus according to the exemplary embodiment.

FIG. 6 shows a flowchart showing an example of a processing flow of the terminal apparatus according to the exemplary embodiment.

### DETAILED DESCRIPTION

The invention will be now described herein with reference to illustrative exemplary embodiments. Those skilled in the art will recognize that many alternative exemplary embodiments can be accomplished using the teachings of the present invention and that the invention is not limited to the exemplary embodiments illustrated for explanatory purposes.

### First Example Embodiment

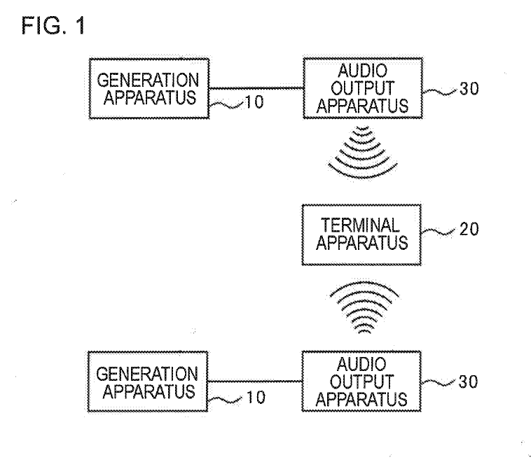

First, an overview of an exemplary embodiment will be briefly described. As shown in FIG. 1, an information providing system according to an exemplary embodiment includes a generation apparatus 10, a terminal apparatus 20, and an audio output apparatus 30. There are multiple pairs of the generation apparatus 10 and the audio output apparatus 30. In the example shown in FIG. 1, the generation apparatus 10 and the audio output apparatus 30 are physically and/or logically divided, but the generation apparatus 10 and the audio output apparatus 30 may be physically/logically integrated with each other.

Each of the multiple generation apparatuses 10 superimposes a variety of information on a variety of audio data. For example, the generation apparatus 10 superimposes a variety of information on audio data transmitted and received as broadcast waves of a television or a radio, superimposes a variety of information on audio data transmitted and received through a telephone line, or superimposes a variety of information on audio data of a ringtone (sound notifying an incoming call) outputted from a telephone.

Methods for superimposing a variety of information on a variety of audio data in the multiple generation apparatuses 10 are the same, in which the variety of information is encoded by spreading codes, and then, the encoded information is superimposed on the audio data. However, spreading codes used by the respective multiple generation apparatuses 10 are different from each other.

For example, a spreading code such as a television spreading code (which may be a spreading code for each broadcasting station or a broadcasting channel), a radio spreading code (which may be a spreading code for each broadcasting station or a broadcasting channel), or a telephone spreading code is determined in advance for each kind of audio or an attribute thereof. Further, each of the multiple generation apparatuses 10 encodes a variety of information using-predetermined spreading codes in association with the own apparatus and superimposes the results on audio data.

The audio output apparatus 30 processes the audio data on which the variety of information is superimposed, and outputs sound through a speaker.

The terminal apparatus 20 (for example, a mobile phone, a smartphone, a tablet, a game machine, a personal computer, or the like) collects audios outputted from the audio output apparatus 30 using a microphone, and generates audio data. Further, the terminal apparatus 20 receives designation of a spreading code to be used for extraction of information from a user. For example, the terminal apparatus 20 outputs information corresponding to each of multiple spreading codes of “television”, “radio”, “telephone”, or the like, and receives one selection from the choices. Then, the terminal apparatus 20 extracts information that is superimposed on audio data using the spreading code selected by the user.

According to the system of this exemplary embodiment, even in a case where multiple kinds of audios are mixed in audio data collected and generated by the terminal apparatus 20 (for example, audio data in which audios of a television, a radio, or a telephone are mixed), it is possible to extract desired information.

Next, an example of a hardware configuration of the generation apparatus 10 and the terminal apparatus 20 according to this exemplary embodiment will be described. Respective functional units of each of the generation apparatus 10 and the terminal apparatus 20 according to this exemplary embodiment may be implemented by an arbitrary combination of hardware and software including, as main components, a central processing unit (CPU) of an arbitrary computer, a memory, a program loaded on the memory, a storage unit (capable of storing a program stored at an apparatus delivery stage in advance and a program downloaded from a storage medium such as a compact disc (CD) or a server on the Internet) such as a hard disk that stores the program, and a network connection interface. It will be noted to those skilled in the art that there are various modification examples in methods and apparatuses for realizing the above-described configuration.

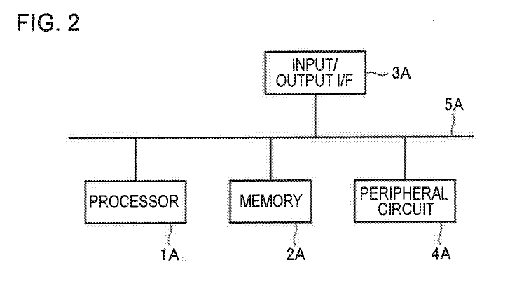

FIG. 2 is a block diagram illustrating a hardware configuration of each of the generation apparatus 10 and the terminal apparatus 20 according to the exemplary embodiment. As shown in FIG. 2, each of the generation apparatus 10 and the terminal apparatus 20 according to the exemplary embodiment includes a processor 1A, a memory 2A, and an input and output interface 3A, a peripheral circuit 4A, and a bus 5A. The peripheral circuit 4A includes various modules. The peripheral circuit 4A may not be included.

The bus 5A is a data transmission path through which the processor 1A, the memory 2A, the peripheral circuit 4A, and the input and output interface 3A transmit and receive data with one another. The processor 1A is a calculation processing apparatus of a central processing unit (CPU), a graphics processing unit (GPU), or the like, for example. The memory 2A is a memory such as a random access memory (RAM) or a read only memory (ROM), for example. The input and output interface 3A includes an interface for acquiring information from an input apparatus (for example, a keyboard, a mouse, a microphone, or the like), an external apparatus, an external server, an external sensor, or the like, an interface for outputting information to an output apparatus (for example, a display apparatus, a speaker, a printer, a mailer, or the like), an external apparatus, an external server, or the like. The processor 1A may output commands to the respective modules, and may perform calculation on the basis of the calculation results.

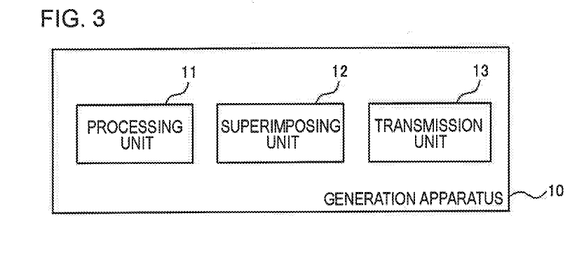

Next, functions of the generation apparatus 10 according to the exemplary embodiment will be described. As shown in FIG. 3, the generation apparatus 10 includes a processing unit 11, a superimposing unit 12, and a transmission unit 13.

The processing unit 11 encodes information to be transmitted (electronic data) using a predetermined spreading code to generate spread encoded data. That is, the processing unit 11 multiplies information by a spreading code to generate spread encoded data. Details of the spreading code are matters of design, and various techniques such as a PN code, or the like may be employed. Information to be transmitted may be text data such as a URL or the like, may be image data, or may be other types of data.

In this exemplary embodiment, for example, a television spreading code (which may be a spreading code for each broadcasting station or each broadcasting channel), a radio spreading code (which may be a spreading code for each broadcasting station or each broadcasting channel), or a telephone spreading code is determined in advance according to each kind of audio or an attribute thereof. Further, each processing unit 11 of the multiple generation apparatuses 10 encodes a variety of information using a spreading code (for example, a spreading code stored in the own apparatus) determined in association with the own apparatus.

The superimposing unit 12 superimposes spread encoded data generated by the processing unit 11 on audio data (audio waveforms) which is not encoded by a spreading code to generate superimposed data. For example, the superimposing unit 12 multiplies audio data by spread encoded data to generate superimposed data.

The encoding of information and the superimposing method of audio data are matters of design, and various techniques may be employed. For example, the technique disclosed in Japanese Patent Application Publication No. 2011-215189 may be used.

The transmission unit 13 transmits superimposed data to an external apparatus. The transmission unit 13 may transmit the superimposed data using various transmission units. For example, the transmission unit 13 may transmit the superimposed data as broadcast waves of a television or a radio. Further, the transmission unit 13 may transmit the superimposed data through a telephone line. Furthermore, the transmission unit 13 may transmit the superimposed data through a communication network such as the Internet. The superimposed data transmitted from the transmission unit 13 may be acquired in the audio output apparatus 30.

In a case where the generation apparatus 10 and the audio output apparatus 30 are physically and/or logically integrated, transmission and reception of superimposed data between the generation apparatus 10 and the audio output apparatus 30 are not necessary. In this case, the generation apparatus 10 may not include the transmission unit 13.

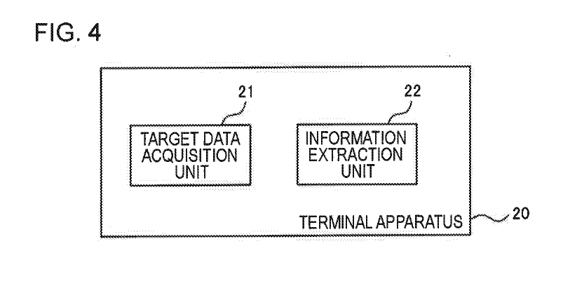

Next, a function of the terminal apparatus 20 according to the first exemplary embodiment will be described. As shown in FIG. 4, the terminal apparatus 20 includes a target data acquisition unit 21 and an information extraction unit 22. The terminal apparatus 20 corresponds, for example, to a mobile phone, a smartphone, a tablet, a game machine, a personal computer, or the like. The target data acquisition unit 21 and the information extraction unit 22 are implemented by installing predetermined software in the terminal apparatus 20.

The target data acquisition unit 21 acquires target data. The target data represents superimposed data or data obtained by converting sound (sound output from the audio output apparatus 30) reproduced on the basis of the superimposed data into an electric signal using a microphone.

For example, the target data acquisition unit 21 may collect sound from the audio output apparatus 30 through the microphone, and may convert the output sound into an electric signal to acquire target data. In addition, the terminal apparatus 20 may receive superimposed data transmitted from the generation apparatus 10. A communication unit between the generation apparatus 10 and the terminal apparatus 20 is not particularly limited.

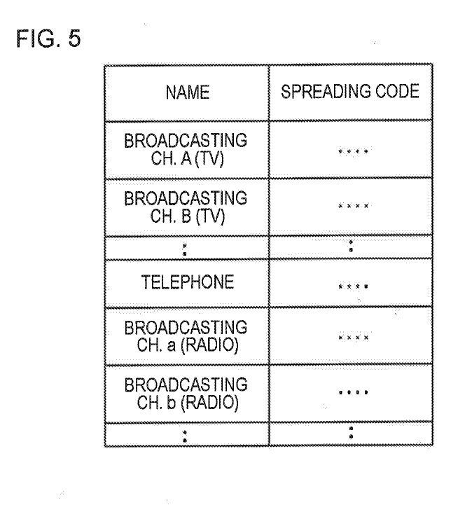

The information extraction unit 22 retains multiple spreading codes in advance. The information extraction unit 22 retains spreading codes determined in advance according to each kind of audio or an attribute thereof, such as a television spreading code (which may be a spreading code for each broadcasting station or each broadcasting channel), a radio spreading code (which may be a spreading code for each broadcasting station or each broadcasting channel), or a telephone spreading code. FIG. 5 shows an example of spreading codes retained by the information extraction unit 22. In the example of FIG. 5, identification information (name) is stored in association with each of multiple spreading codes. The information extraction unit 22 may retain spreading codes corresponding to each of at least two from broadcast data transmitted and received as broadcast waves, telephone data transmitted and received through a telephone line, and data on a ringtone outputted from a telephone.

The information extraction unit 22 receives an operation of selecting one spreading code from multiple spreading codes from a user. For example, the information extraction unit 22 may present choices of the multiple spreading codes through a display, and may receive one selection from the multiple spreading codes. For example, the information extraction unit 22 may present choices using names shown in FIG. 5. The information extraction unit 22 may hierarchically present information and may receive multiple inputs to receive a selection of one spreading code.

Further, the information extraction unit 22 extracts information from target data acquired by the target data acquisition unit 21 by a decoding process using the spreading code selected by the user. Details of the decoding process are matters of design, and various techniques may be employed. For example, the technique disclosed in Japanese Patent Application Publication No. 2011-215189 may be used.

After the information is extracted from the target data by the information extraction unit 22, the terminal apparatus 20 may execute a predetermined process using the extracted information.

For example, in a case where the extracted information is a URL, the terminal apparatus 20 may access an address represented by the URL. Further, before the access, guidance such as “Do you want to access a URL? Yes or No” may be output on a display. Further, if an input of “Yes” is received, the terminal apparatus 20 may access the URL.

Further, in a case where the extracted information is other text information, the text information may be displayed on the display. In addition, before the display, a guidance such as “Do you want to display text information? Yes or No” may be output on the display. In a case where an input of “Yes” is received, the text information may be displayed on the display.

In a case where the extracted information is an image, information on the image may be displayed on the display. Further, before the display, guidance such as “Do you want to display an image? Yes or No” may be output on the display. Further, if an input of “Yes” is received, the image may be displayed on the display.

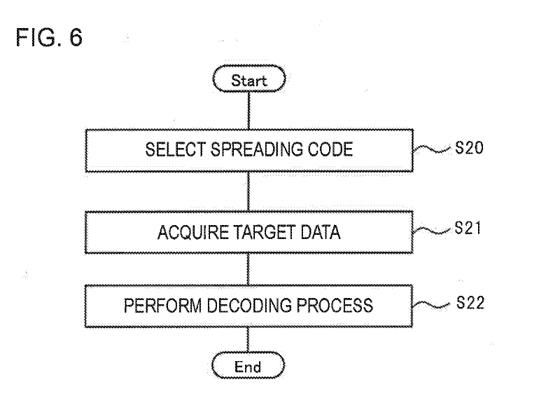

Here, an example of a processing flow of the terminal apparatus 20 will be described using a flowchart of FIG. 6.

The following processes are started according to an operation of a user, that is, an operation of activating predetermined software, an operation of starting a predetermined process included in the software, or the like.

First, the terminal apparatus 20 receives an operation of selecting a spreading code (S20). For example, the terminal apparatus 20 displays names (see FIG. 5) corresponding to multiple spreading codes on a display, and receives an operation of selecting one from the choices. The terminal apparatus 20 may receive an operation of changing the selection of the spreading code at an optional timing thereafter.

After S20, the terminal apparatus 20 starts sound collection and generation of audio data through a microphone. Superimposed data (target data) output from the audio output apparatus 30 is acquired by the terminal apparatus 20 through this process (S21).

Then, the terminal apparatus 20 acquires information from the target data by a decoding process using the spreading code selected in S20 (S22).

Thereafter, the terminal apparatus 20 executes a predetermined process using the extracted information. For example, the terminal apparatus 20 accesses an address represented by the extracted information (URL), or displays the extracted information (text information, an image, or the like) on the display.

Here, a specific example of this exemplary embodiment will be described.

### Specific Example 1-1

In Specific Example 1-1, spread encoded data is superimposed on broadcast audio data transmitted and received as broadcast waves of a television (or a radio). For example, information (URL or the like) relating to a television program is encoded using a spreading code, and the result is superimposed on broadcast audio data. In this example, the generation apparatus 10 is a device which is installed in a broadcasting station of a television or a radio, and the audio output apparatus 30 corresponds to the television or the radio.

A viewer (an audience) operates the terminal apparatus 20 while watching a broadcast on the television (or radio), and activates predetermined software. Further, the viewer performs an operation of selecting a spreading code. For example, the viewer selects a medium (television or radio) being viewed or selects a channel being viewed, to thereby select a spreading code corresponding thereto.

The terminal apparatus 20 collects sound of a television program output from the television (or radio), and generates audio data. Further, the terminal apparatus 20 performs a decoding process using the selected spreading code, and extracts predetermined information from audio data, for example, information (URL or the like) relating to the television program. The terminal apparatus 20 displays the extracted information on the display, or accesses the extracted URL.

### Specific Example 1-2

In Specific Example 1-2, spread encoded data is superimposed on audio data transmitted and received through a telephone line. Here, an example in which spread encoded data is superimposed on audio data of an automatically-reproduced telephone survey will be described.

On the telephone caller side, audio data of an automatically-reproduced telephone survey is generated and stored. A URL of a website that accepts an answer to the survey is superimposed on the stored audio data.

In a case where a call is made from the telephone caller side to a predetermined telephone number and the call is connected, reproduction of the audio data is started. At the beginning of the audio data, guidance may be given indicating that the URL is superimposed on the audio data.

A telephone receiver side operates the terminal apparatus 20 while listening to the sound from the telephone, and activates predetermined software. Further, the telephone receiver side performs an operation of selecting a spreading code. For example, the telephone receiver side selects “telephone” from multiple choices in order to select a spreading code corresponding thereto.

The terminal apparatus 20 collects the sound output from the telephone and generates audio data. Further, the terminal apparatus 20 performs a decoding process using the selected spreading code, and extracts predetermined information from the audio data, that is, extracts the URL of the predetermined website. The terminal apparatus 20 accesses the extracted URL, processes the acquired data, and displays the website on the display. Then, the terminal apparatus 20 accepts answers to the survey through the website, and transmits the results to a predetermined server.

### Specific Example 1-3

In Specific Example 1-3, spread encoded data is superimposed on broadcast audio data transmitted and received as television broadcast waves. Specifically, information for identifying a game or information used in the game (for example, keywords relating to broadcasting content of the day concerned) is superimposed on gamified audio data of a television program. In this example, the generation apparatus 10 is a device that is installed in a broadcasting station of a television or a radio, and the audio output apparatus 30 is a television or a radio.

A viewer operates the terminal apparatus 20 (a game machine, a smartphone, a tablet, or the like) while watching a television program, and activates predetermined software. Further, the viewer performs an operation of selecting a spreading code. For example, the viewer selects a medium (a television or a radio) being viewed or selects a channel being viewed to select a spreading code corresponding thereto.

The terminal apparatus 20 collects the sound of a television program output from the television and generates audio data. Further, the terminal apparatus 20 performs a decoding process using the selected spreading code, and extracts predetermined information from the audio data, specifically, information for identifying a game or information (for example, keywords relating to broadcasting content of the day) used in the game.

Then, the terminal apparatus 20 activates a game (software) designated as the extracted “information for specifying the game”, and delivers the extracted “information (for example, keywords relating to broadcasting content of the day concerned) used in the game” to the software. The software of the game executes a predetermined process using the acquired “information (for example, keywords relating to broadcasting content of the day concerned) used in the game”. Thus, it is possible to synchronize the content of the game with the content of the television.

A modification example of this specific example will be described. As functions of the game, collection of sound of a television or radio program and generation of audio data, reception of selection of a spreading code, extraction of information (for example, keywords relating to broadcasting content of the day concerned) used in the game from audio data of the television or radio program using the selected spreading code, execution of a predetermined process using the extracted information, and the like may be realized. In this case, a viewer operates the terminal apparatus 20 (a game machine, a smartphone, a tablet, or the like) while watching the television program, activates a specific function of a predetermined game, and performs a predetermined operation such as selection of a spreading code.

### Specific Example 1-4

In Specific Example 1-4, spread encoded data is superimposed on a ringtone of a telephone. In a case where a receiver side telephone (the generation apparatus 10 and the audio output apparatus 30) receives an incoming phone call, telephone book data registered in the own apparatus is retrieved using a caller-side telephone number as a key, and caller side-related information is extracted. The extracted related information may be a name, a title, a photo, or the like of the caller.

The receiver-side telephone encodes the extracted related information using a predetermined spreading code, and superimposes the result on audio data of the ringtone. Further, the receiver-side telephone processes the audio data of the ringtone on which the related information of the caller is superimposed as spread encoded data, and outputs the ringtone.

The receiver upon hearing the ringtone operates the terminal apparatus 20, and activates predetermined software. Further, the receiver performs an operation of selecting a spreading code. For example, the receiver selects a telephone from multiple choices in order to select a spreading code corresponding thereto.

The terminal apparatus 20 collects the ringtone output from the telephone, and generates audio data. Further, the terminal apparatus 20 performs a decoding process using the selected spreading code, and extracts predetermined information from the audio data, that is, caller-related information. The terminal apparatus 20 displays the extracted related information on a display. Thus, the receiver can identify the caller on the basis of the related information displayed on the display.

In the above description, the receiver-side telephone functions as the generation apparatus 10 and the audio output apparatus 30, but as a modification example, the receiver-side telephone may function as an audio output apparatus 30, and a private branch exchange (PBX) of the receiver side may function as the generation apparatus 10. That is, the PBX may perform generation of spread encoded data and generation of superimposed data.

### Specific Example 1-5

In Specific Example 1-5, spread encoded data is superimposed on a ringtone of a telephone. In a case where a receiver-side telephone (the generation apparatus 10 and the audio output apparatus 30) receives an incoming phone call, the receiver-side telephone receives caller-related information including the caller's telephone number. The received related information may be a name, a title, a photo, a current position, or the like of the caller.

The receiver-side telephone encodes the received related information using a predetermined spreading code, and superimposes the result on audio data of the ringtone. Further, the receiver-side telephone processes the audio data of the ringtone on which the caller-related information is superimposed as spread encoded data, and outputs the ringtone.

The receiver upon hearing the ringtone operates the terminal apparatus 20, and activates predetermined software. Further, the receiver performs an operation of selecting a spreading code. For example, the receiver selects “telephone” from multiple choices to select a spreading code corresponding thereto.

The terminal apparatus 20 collects the ringtone output from the telephone, and generates audio data. Further, the terminal apparatus 20 performs a decoding process using the selected spreading code, and reads predetermined information from the audio data, that is, extracts the caller-related information. The terminal apparatus 20 displays the extracted related information on a display. Thus, the receiver can identify the caller on the basis of the related information displayed on the display.

In the above description, the receiver-side telephone functions as the generation apparatus 10 and the audio output apparatus 30, but as a modification example, the receiver-side telephone may function as the audio output apparatus 30, and a receiver-side PBX may function as the generation apparatus 10. That is, the PBX may perform generation of spread encoded data and generation of superimposed data.

### Specific Example 1-6

Specific Example 1-6 is obtained by combining at least two from Specific Examples 1-1 to 1-5.

According to the information providing system according to the above-described exemplary embodiment, even in a case where audios superimposed with information is abundant in the vicinity, and multiple kinds of audios are mixed into audio data collected and generated by the terminal apparatus 20, it is possible to extract desired information.

### Second Exemplary Embodiment

In an information providing system according to a second exemplary embodiment, a configuration of a generation apparatus 10 is different from that of the first exemplary embodiment. Specifically, the information providing system according to the second exemplary embodiment is different from that of the first exemplary embodiment in that a superimposing unit 12 is capable of superimposing multiple pieces of spread encoded data obtained by encoding multiple pieces of information using different spreading codes on common audio data. Other configurations of the information providing system are the same as in the first exemplary embodiment.

Here, specific examples of this exemplary embodiment will be described.

### Specific Example 2-1

In Specific Example 2-1, multiple pieces of spread encoded data are superimposed on arbitrary audio data. Here, the audio data refers to broadcast data transmitted and received as broadcast waves of a television. That is, the generation apparatus 10 is a device that is provided in a broadcasting station of a television or a radio, and the audio output apparatus 30 is a television or a radio.

The multiple pieces of spread encoded data to be superimposed is information (URL or the like) corresponding to each of choices of an answer to a survey. The choices of the answer to the survey may be “Yes” and “No”, or may include other answers (“Don't know” or the like), for example.

In this example, the information extraction unit 22 of the terminal apparatus 20 retains spreading codes corresponding to the respective choices of the answers in advance. Further, the terminal apparatus 20 accepts an answer to the survey from a user to accept selection of a spreading code.

A viewer operates the terminal apparatus 20 while watching a television program, and activates predetermined software. Further, the viewer performs an operation of selecting the spreading code. For example, the viewer may select a television program from multiple choices, may select a broadcasting channel being viewed from multiple broadcasting channels, and then, may select “survey” from multiple choices. Then, the terminal apparatus 20 displays guidance for inputting an answer to the survey (for example, “Yes” or “No) on a display. By answering the survey, one spreading code is selected. The viewer determines an answer on the basis of content of the survey broadcasted through the program. Further, the determined answer is input to the terminal apparatus 20. Thus, the spreading code corresponding to the determined answer is selected.

The terminal apparatus 20 collects sound of the television program output from the television, and generates audio data. Further, the terminal apparatus 20 performs a decoding process using a spreading code corresponding to the input answer to the survey, and extracts predetermined information (URL or the like corresponding to the answer to the survey) from the audio data. The terminal apparatus 20 may display the extracted information on the display, or may access the extracted URL.

A quiz or the like instead of the survey may be employed.

### Specific Example 2-2

In Specific Example 2-2, multiple pieces of spread encoded data are superimposed on a ringtone of a telephone. In a case where a receiver-side telephone (the generation apparatus 10 and the audio output apparatus 30) receives an incoming phone call, the receiver-side telephone retrieves telephone book data which is registered in the own apparatus using a caller-side telephone number as a key, and extracts caller-related information. The extracted related information may be a name, a title, a photo or the like of a caller.

The receiver-side telephone encodes the extracted multiple kinds of related information (the name, the title, the photo, or the like of the caller) using spreading codes corresponding thereto, and superimposes the result on audio data of a ringtone. Further, the receiver-side telephone processes the audio data of the ringtone superimposed with the multiple kinds of related information of the caller as spread encoded data, and outputs the ringtone.

A receiver upon hearing the ringtone operates the terminal apparatus 20, and activates predetermined software. Further, the receiver performs an operation of selecting a spreading code. For example, the receiver selects “telephone” from multiple choices, and selects any one from the multiple kinds of related information. Thus, a spreading code corresponding to the kind of the selected related information is selected.

The terminal apparatus 20 collects the ringtone output from the telephone, and generates audio data. Further, the terminal apparatus 20 performs a decoding process using the selected spreading code, and extracts a predetermined kind of related information from the audio data. The terminal apparatus 20 displays the extracted information on a display. Thus, the receiver may identify the caller on the basis of the display related information.

In the above description, the receiver-side telephone functions as the generation apparatus 10 and the audio output apparatus 30, but as a modification example, the receiver-side telephone may function as the audio output apparatus 30, and a PBX of the receiver side may function as the generation apparatus 10. That is, the PBX may perform generation of spread encoded data and generation of superimposed data.

### Specific Example 2-3

In Specific Example 2-3, multiple pieces of spread encoded data are superimposed on a ringtone of a telephone. In a case where a receiver-side telephone (the generation apparatus 10 and the audio output apparatus 30) receives an incoming phone call, the receiver-side telephone receives multiple kinds of related information of a caller including the caller's telephone number. The extracted related information may be a name, a title, a photo, a current position, or the like of a caller.

The receiver-side telephone encodes the received multiple kinds of related information (the name, title, photo, current position, or the like of the caller) using spreading codes corresponding thereto, and superimposes the result on audio data of the ringtone. Further, the receiver-side telephone processes the audio data of the ringtone on which the multiple kinds of related information of the caller are superimposed as spread encoded data, and outputs the ringtone.

A receiver upon hearing the ringtone operates the terminal apparatus 20, and activates predetermined software. Further, the receiver performs an operation of selecting a spreading code. For example, the receiver selects “telephone” from multiple choices, and selects any one information from multiple kinds of related information. Thus, a spreading code corresponding to the kind of the selected related information is selected.

The terminal apparatus 20 collects the ringtone output from the telephone, and generates audio data. Further, the terminal apparatus 20 performs a decoding process using the selected spreading code, and extracts a predetermined kind of related information from the audio data. The terminal apparatus 20 displays the extracted related information on a display. Thus, it is possible to identify the caller on the basis of the display related information.

In the above description, the receiver-side telephone functions as the generation apparatus 10 and the audio output apparatus 30, but as a modification example, the receiver-side telephone may function as the audio output apparatus 30, and a receiver-side PBX may function as the generation apparatus 10. That is, the PBX may perform generation of spread encoded data and generation of superimposed data.

### Specific Example 2-4

Specific Example 2-4 is an example obtained by combining at least two from Specific Examples 2-1 to 2-3.

### Specific Example 2-5

Specific Example 2-5 is an example obtained by combining at least two from Specific Examples 1-1 to 1-5 and Specific Examples 2-1 to 2-3.

According to the above-described exemplary embodiment, it is possible to achieve the same advantageous effects as in the first exemplary embodiment. Further, according to the information providing system of this exemplary embodiment, it is possible to superimpose multiple pieces of spread encoded data encoded using different spreading codes on audio data for transmission and reception. In this case, it is possible to selectively extract predetermined information without extracting all of the multiple pieces of superimposed information.

Here, a modification example which can be applied to the first exemplary embodiment and the second exemplary embodiment will be described. In the modification example, a configuration in which the terminal apparatus 20 and the audio output apparatus 30 are physically and/or logically integrated may be used. As an example of an apparatus that includes the functions of the terminal apparatus 20 and the audio output apparatus 30 (hereinafter, “an apparatus of a modification example”), a mobile phone, a smartphone, a tablet terminal, a personal computer, or the like may be illustrated, but the invention is not limited thereto. The apparatus of the modification example may execute the above-described process implemented by the audio output apparatus 30 and the process implemented by the terminal apparatus 20. For example, the apparatus of the modification example may include a telephone function. Further, the apparatus of the modification example may output an audio of a call (call sound, ringing sound, or the like) of a telephone, may collect the audio using a microphone or may acquire audio data before output, and may extract information superimposed on the audio data. In addition, the apparatus of the modification example may have a function of receiving and outputting broadcast waves of a television or a radio. Furthermore, the apparatus of the modification example may output an audio of a television or a radio (audio of a program), may collect the audio using a microphone or may acquire audio data before output, and may extract information superimposed on the audio data.

Hereinafter, examples of reference appendixes will be added.

### APPENDIX 1

A terminal apparatus including:

a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and

an information extraction unit configured to retain a plurality of spreading codes and extract the information from the target data using a spreading code selected by a user.

### APPENDIX 2

The terminal apparatus according to Appendix 1,

wherein the superimposed data includes at least two from broadcast data transmitted and received as broadcast waves, telephone data transmitted and received through a telephone line, and data on a ringtone outputted from a telephone, and the information extraction unit retains a spreading code corresponding to each data.

### APPENDIX 3

The terminal apparatus according to Appendix 1 or 2,

wherein the target data acquisition unit acquires target data which is: superimposed data obtained by superimposing a plurality of pieces of spread encoded data on non-spread encoded audio data, the spread encoded data obtained by encoding a plurality of pieces of information using spreading codes different from each other; or data obtained by converting sound reproduced on the basis of the superimposed data into an electrical signal.

### APPENDIX 4

The terminal apparatus according to any one of Appendixes 1 to 3,

wherein the information is a URL.

### APPENDIX 5

An information providing system including:

the terminal apparatus according to any one of Appendixes 1 to 4;

a generation apparatus that transmits superimposed data obtained by superimposing information encoded by a spreading code on non-spread encoded audio data; and

an audio output apparatus that outputs an audio on the basis of the superimposed data.

### APPENDIX 6

An information providing system including:

the terminal apparatus according to any one of Appendixes 1 to 4; and

an apparatus that superimposes spread encoded information on non-spread encoded audio data and outputs an audio on the basis of the superimposed data.

### APPENDIX 7

A terminal apparatus processing method causing a computer to execute:

acquiring target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and

retaining a plurality of spreading codes and extracting the information from the target data using a spreading code selected by a user.

### APPENDIX 8

The terminal apparatus processing method according to Appendix 7,

wherein the superimposed data includes at least two from broadcast data transmitted and received as broadcast waves, telephone data transmitted and received through a telephone line, and data on a ringtone outputted from a telephone, and

wherein the computer retains a spreading code corresponding to each of the respective broadcast data, the telephone data, and the ringtone data.

### APPENDIX 9

The terminal apparatus processing method according to Appendix 7 or 8,

wherein in the step of acquiring target data, the computer acquires target data which is: superimposed data obtained by superimposing a plurality of pieces of spread encoded data on non-spread encoded audio data, the spread encoded data obtained by encoding a plurality of pieces of information using spreading codes different from each other; or data obtained by converting sound reproduced on the basis of the superimposed data into an electrical signal.

### APPENDIX 10

The terminal apparatus processing method according to any one of Appendixes 7 to 9,

wherein the information is a URL.

### APPENDIX 11

A program that causes a computer to function as:

a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and

an information extraction unit configured to retain a plurality of spreading codes and extract the information from the target data using a spreading code selected by a user.

### APPENDIX 12

The program according to Appendix 11,

wherein the superimposed data includes at least two from broadcast data transmitted and received as broadcast waves, telephone data transmitted and received through a telephone line, and data on a ringtone outputted from a telephone, and

wherein the computer retains a spreading code corresponding to each of the respective broadcast data, the telephone data, and the ringtone data.

### APPENDIX 13

The program according to Appendix 11 or 12,

wherein the target data acquisition unit acquires target data which is: superimposed data obtained by superimposing a plurality of pieces of spread encoded data on non-spread encoded audio data, the spread encoded data obtained by encoding a plurality of pieces of information using spreading codes different from each other; or data obtained by converting sound reproduced on the basis of the superimposed data into an electrical signal.

### APPENDIX 14

The program according to any one of Appendixes 11 to 13,

wherein the information is a URL.

It is apparent that the present invention is not limited to the above embodiment, and may be modified and changed without departing from the scope and spirit of the invention.

What is claimed is:

1. A terminal apparatus comprising:
a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and
an information extraction unit configured to retain a plurality of spreading codes and extract the information from the target data using a spreading code selected by a user.

2. The terminal apparatus according to claim 1,
wherein the superimposed data includes at least two from broadcast data transmitted and received as broadcast waves, telephone data transmitted and received through a telephone line, and data on a ringtone outputted from a telephone, and the information extraction unit retains a spreading code corresponding to each of the data.

3. The terminal apparatus according to claim 1,
wherein the target data acquisition unit acquires target data which is: superimposed data obtained by superimposing a plurality of pieces of spread encoded data on non-spread encoded audio data, the spread encoded data obtained by encoding a plurality of pieces of information using spreading codes different from each other; or data obtained by converting sound reproduced on the basis of the superimposed data into an electrical signal.

4. The terminal apparatus according to claim 1,
wherein the information is a URL.

5. An information providing system comprising:
the terminal apparatus according to claim 1;
a generation apparatus that transmits superimposed data obtained by superimposing spread encoded information on non-spread encoded audio data; and
an audio output apparatus that outputs an audio on the basis of the superimposed data.

6. An information providing system comprising:
the terminal apparatus according to claim 1; and
an apparatus that superimposes spread encoded information on non-spread encoded audio data and outputs an audio on the basis of the superimposed data.

7. A terminal apparatus processing method causing a computer to execute:
acquiring target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and
retaining a plurality of spreading codes and extracting the information from the target data using a spreading code selected by a user.

8. A non-transitory storage medium storing a program that causes a computer to function as:
a target data acquisition unit configured to acquire target data which is: superimposed data obtained by superimposing spread encoded data on non-spread encoded audio data, the spread encoded data obtained by encoding information using a spreading code; or data obtained by converting sound reproduced on the basis of the superimposed data into an electrical signal; and
an information extraction unit configured to retain a plurality of spreading codes and to extract the information from the target data using a spreading code selected by a user.
